(19) United States
(12) Patent Application Publication
(10) Pub. No.: US 2003/0183344 A1
(43) Pub. Date: Oct. 2, 2003

(54) Hand-held tape dispenser

(76) Inventor: Chen-Yuan Lai, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 10/134,620

(22) Filed: Apr. 30, 2002

(30) Foreign Application Priority Data
Mar. 28, 2002 (TW) 91203865

(51) Int. Cl. B44C 7/00

(52) U.S. Cl. 156/577; 156/574

(57) ABSTRACT

A tape dispenser comprises a housing, which is constructed from a first and a second housing pieces. The housing has a first aperture and a second aperture. A tape seat has a base wall and two side walls. A tape wheel is installed in between the side walls for free rotating. A second roller is pivoted at front side of the base wall. The tape seat is detachably installed to the housing for a third aperture formed at between the end of the base wall and the housing. A coupler link is received in the housing with the midsection thereof pivoted to the housing. A press member is received in the housing for displacing within a predetermined distance, which has a part extending out of the housing via the first aperture and has an end pivoted to an end of the coupler link. A cutter is received in the housing for displacing within a predetermined distance, which has an end thereof pivoted to the second segment of the coupler link, and elastic member has an end being against the housing and the other end being against the press member. User presses the press member can drive the cutter extending out of the housing via the second aperture.

### FIELD OF THE INVENTION

The present invention relates to a tape dispenser, and more particularly to a handheld tape dispenser, which can protect user from being hurt.

### BACKGROUND OF THE INVENTION

A conventional tape dispenser has an exposed blade, which may hurt user, especial the children. So, there were some inventions of the tape dispensers to protect user from being hurt.

There are two solutions for the protect apparatus of the tape dispenser in prior art: 1) provides a cover covering the blade, such as U.S. Pat. No. 5,928,466, U.S. Pat. No. 5,456,790 and U.S. Pat. No. 5,393,367 etc., 2) hides the blade in the housing. The blade is only extended out of the housing when it is needed to cut the tape off, such as U.S. Pat. No. 6,176,409, U.S. Pat. No. 4,065,519 and U.S. Pat. No. 5,288,362 etc.

U.S. Pat. No. 6,176,409 taught a tape dispenser, which has a pressing plate for linear displacing, a swing block pivoted in the tape dispenser at midsection thereof and a blade holder secured a blade at an end thereof for linear displacing too. In initial, the blade is received in the tape dispenser. Presses the pressing plate will make it pushing an end of the swing block. At this time, the opposite end of the swing block will push the blade seat to make the blade extending out of the tape dispenser.

I found the pressing plate can not drive the swing block exactly after a long time use. Besides, there was nothing to hold the tape tail, which extends out of the tape dispenser. So, the tape tail is easy to run back into the tape dispenser after being cut.

### SUMMARY OF THE INVENTION

The primary object of the present invention is to provide a tape dispenser, which can drive the cutter extending out exactly.

The secondary objective of the present invention is to provide a tape dispenser, which can hold the tape tail.

According to the objective of the present invention, a tape dispenser comprises a housing, which has a receiving chamber therein and an opening at a side thereof. The housing has a first aperture and a second aperture. A coupler link is received in the housing and is pivoted to the hosing at midsection thereof. A press member is received in the housing for displacing within a predetermined distance, which has a part extending out of the housing via the first aperture and has an end pivoted to an end of the coupler link. A cutter is received in the housing for displacing within a predetermined distance, which has an end thereof pivoted to the opposite end of the coupler link, and an elastic member has an end being against the housing and the other end being against the press member.

### BRIEF DESCRIPTION OF THE DRAWINGS

FIG. 1 is an exploded view of a prefer embodiment of the present invention;

FIG. 2 is a front side view of the prefer embodiment of the present invention in combination;

FIG. 3 is a left side view of the prefer embodiment of the present invention;

FIG. 4 is an exploded view in part of the prefer embodiment of the present invention;

FIG. 5 is a sectional view of the prefer embodiment of the present invention;

FIG. 6 is a sectional view in part of the prefer embodiment of the present invention, showing the cutter received in the housing;

FIG. 7 is a sectional view following FIG. 6, showing the pressing member being pressed to driving the cutter extending out of the housing, and

FIG. 8 is a perspective view of the prefer embodiment of the present invention in operating.

### DETAIL DESCRIPTION OF THE INVENTION

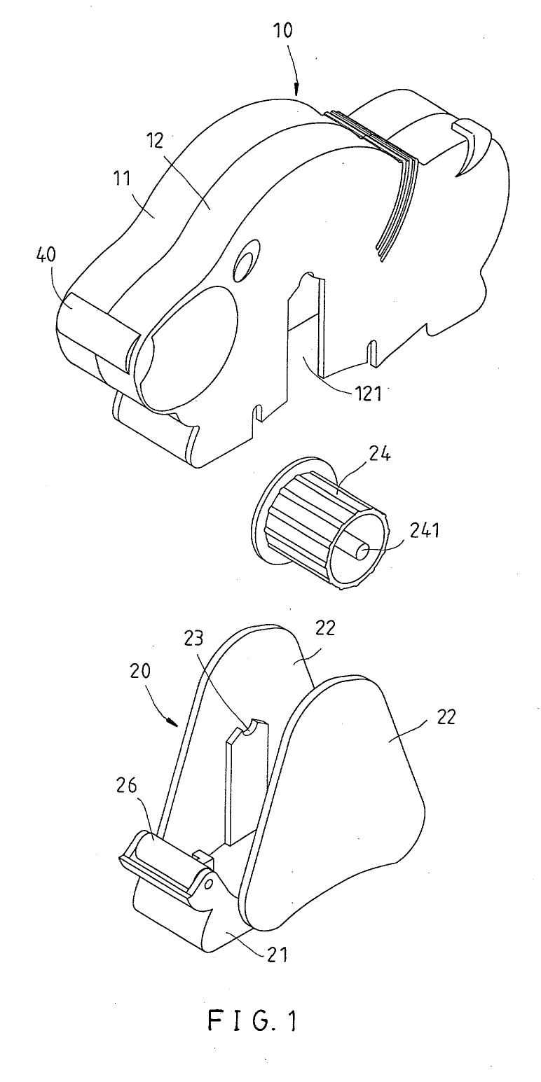

Please refer to FIGS. from FIG. 1 to FIG. 5, the prefer embodiment of the present invention provides a tape dispenser, which comprises:

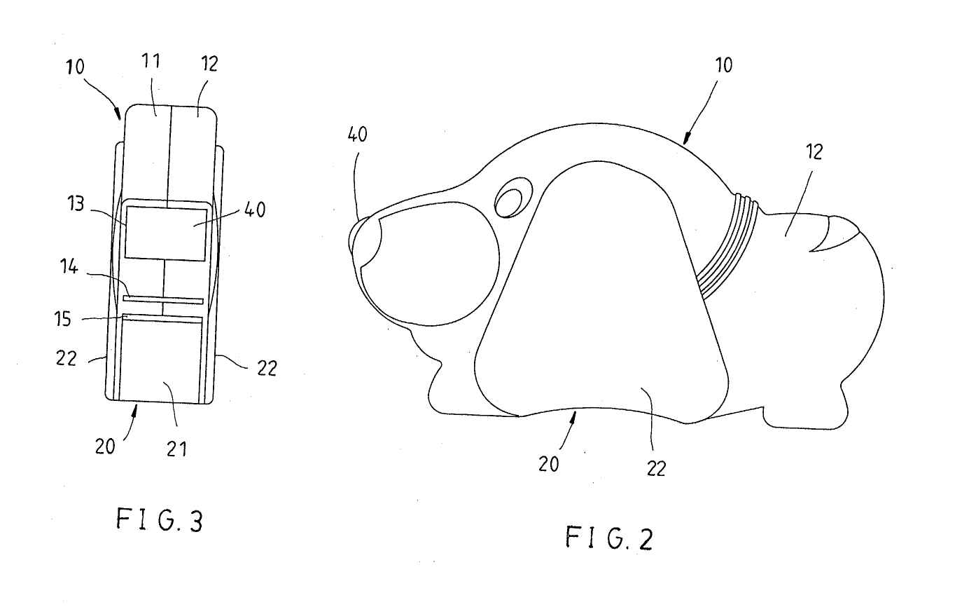

A housing 10, please refer to FIG. 2 and FIG. 3, consists of a first housing piece 11 and a second housing piece 12 to make the housing 10 has a receiving chamber therein and an opening at bottom side thereof. The first and the second housing pieces 11 and 12 each has a tunnel 111 and 121 extending to the opening of the housing 10. The housing 10 has a first aperture 13 and a second aperture 14 at the left end thereof.

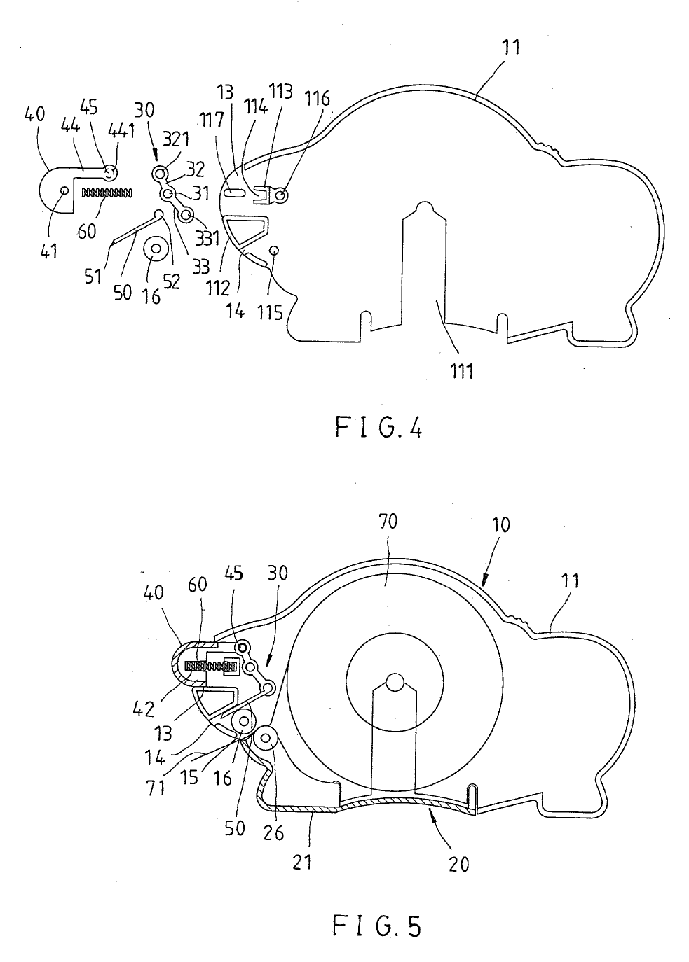

Please refer to FIG. 4, the first housing piece 11 has a block wall 112 between the first aperture 13 and second aperture 14, a seat block 113 behind the first aperture 13 having a notch 114 facing the first aperture 13, a roller seat 115 below the block wall 112, a pivot seat 116 behind the seat block 113 and a guiding slot 117 between the first aperture 13 and the seat block 113.

The second housing piece 12 has the same elements and the corresponding layout as the first housing piece 11 has. So, I do not describe the detail of the second housing piece 12 here.

Please refer to FIG. 1, the tape dispenser of the present invention further comprises a tape seat 20, which has a base wall 21 and two parallel side walls 22. The base wall 21 pivots a second roller 26 at front side thereof. Each side wall 22 has a wheel seat 23 (only shows one wheel seat 23 in FIG. 1) at interior side thereof. A tape wheel 24 has an axial shaft 241. The tape wheel 24 is to mount a tape roll 70 thereon and put it in between the side walls 22 of the tape seat 20 for the opposite ends of the axial shaft 241 received in the wheel seats 23 respectively. Thus, the tape wheel 24 can rotate freely.

The tape seat 20 is installed to the housing 10 from the opening with the side walls 22 positioning at exterior sides of the first and the second housing pieces 11 and 12 respectively and the base wall 21 covering the opening of the housing 10. There is a gap left between the front end of the base wall 21 of tape seat 20 and the end wall of the housing 10, as shown in FIG. 3, to form a third aperture 15 of the housing 10. The first roller 16 in the housing 10 and the second roller 26 on the tape seat 20 are located behind the third aperture 15.

A substantially V-shaped coupler link 30, which is a metal piece element, has a central hole 31 at midsection thereof, a first segment 32 and a second segment 33 at opposite sides of the central hole 31 respectively. The distal ends of the first and the second segments 32 and 33 each has a hole 321 and 331 respectively. The pivot seats 116 on the first and the second housing pieces 11 and 12 are inserted into the opposite ends of the central hole 31 for the coupler link 30 being pivoted to the housing 10 and to be driven to rotate.

A press member 40 is received in the first aperture 13 of the housing 10 having a part extending out of the housing 10. The press member 40 has two rods 41 at opposite sides thereof received in the guiding slots 117 on the first and the second housing pieces 11 and 12 for the press member 40 can displace along the guiding slots 117 and limit the press member 40 only can displace a distance within the range of the guiding slots 117 extended. The press member 40 has a notch 42 at interior end thereof and two parallel arms 44 at two sides of the notch 42 respectively. Each arm 44 has a hole 441. The press member 40 is pivoted to the first segment 32 of the coupler link 30 by means of inserting a pin 45 into the holes 441 of the arms 44 and the hole 321 at the distal end of the first segment 32. Thus, the press member 40 can drive the coupler link 30 to move exactly.

A cutter 50 has a saw-shaped blade portion 51 at an end thereof and two connect rods 52 at opposite end thereof. The cutter 50 is pivoted to the second segment 33 of the coupler link 30 by means of inserting the connect rods 52 into the opposite ends of the hole 331 at the distal end of the second segment 33. At this time, the blade portion 51 of the cutter 50 corresponds to the second aperture 14 of the housing 10. Thus, the coupler link 30 can drive the cutter 50 for the blade portion 51 extending out of the housing 10 via the second aperture 14 and going back into the housing 10.

An elastic member 60, which is a spring in this embodiment, has an end thereof received in the notch 114 of the seat block 113 and has the opposite end thereof received in the notch 42 of the press member 40 to provide a spring force pushing the press member 40.

Please refer to FIG. 5, at the initial position, the rods 41 of press member 40 is stopped at the exterior ends of the guiding slots 117 for the press member having a larger part extending out of the housing 10 via the first aperture 13 and the blade portion 51 of the cutter 50 is received in the housing 10 totally.

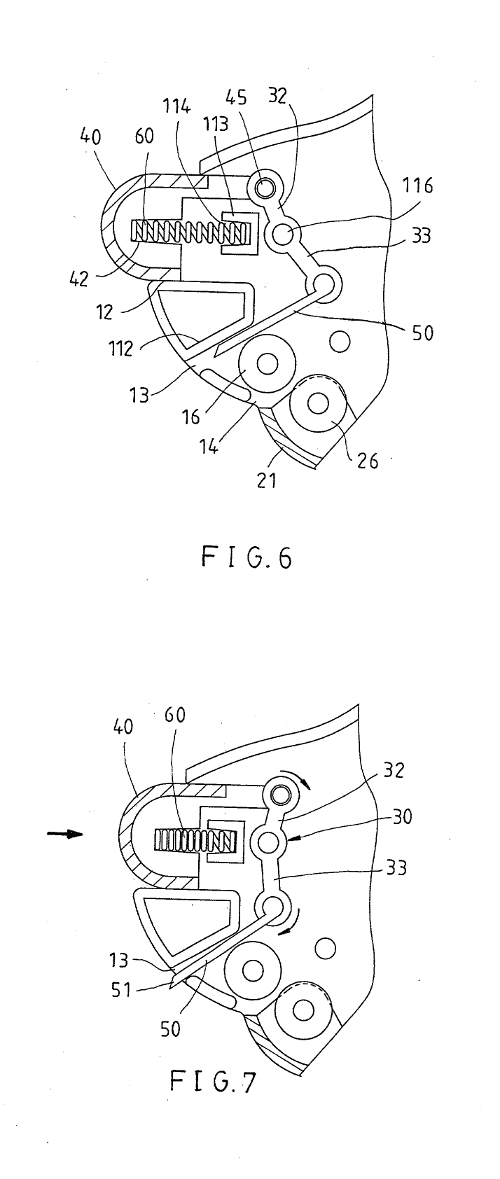

Please refer to FIG. 6, when exerts the press member 40 to make it moving inwards, the press member 40 will drive the first segment 32 of the coupler link 30 moving inwards. At this time, the second segment 33 of the coupler link 30 will be driven to move outwards to driving the blade portion 51 of the cutter 50 extending out of the housing 10 via the second aperture 14.

After the force exerted on the press member 40 has gone, the elastic member 60 will pushing the press member 40 outwards and the cutter 50 will be driven to go back into the housing 10 automatically. The positions of the elements of the tape dispenser of the present invention will return to the initial positions as shown in FIG. 5 again.

In analysis of mechanisms, the press member 40, the coupler link 30, the cutter 50 and the housing 10 construct a four-bar linkage, which is a single-degree-of-freedom mechanisms. So, user presses the press member 40 can constrain the cutter 50 to move. And the press member 40, the coupler link 30 and the cutter 50 are pivoted together with a fixed structure to fix the problem of U.S. Pat. No. 6,176,409.

Please refer to FIG. 1, user first mounts a tape roll 70 on the tape wheel 24 and put it on the tape seat 20. Second, draws the tape 71 out to make it sticking on the second roller 26. Next, installs the tape seat 20 to the housing 10 to make the tape roll 70 received in the housing 10 and the tail of the tape 71 will extend out of the housing 10 via the third aperture 15 as shown in FIG. 5. The tape 71 is stuck on the second roller 26 to prevent the tail of the tape 71 running back into the housing 10, especially after cutting the tape 71 off.

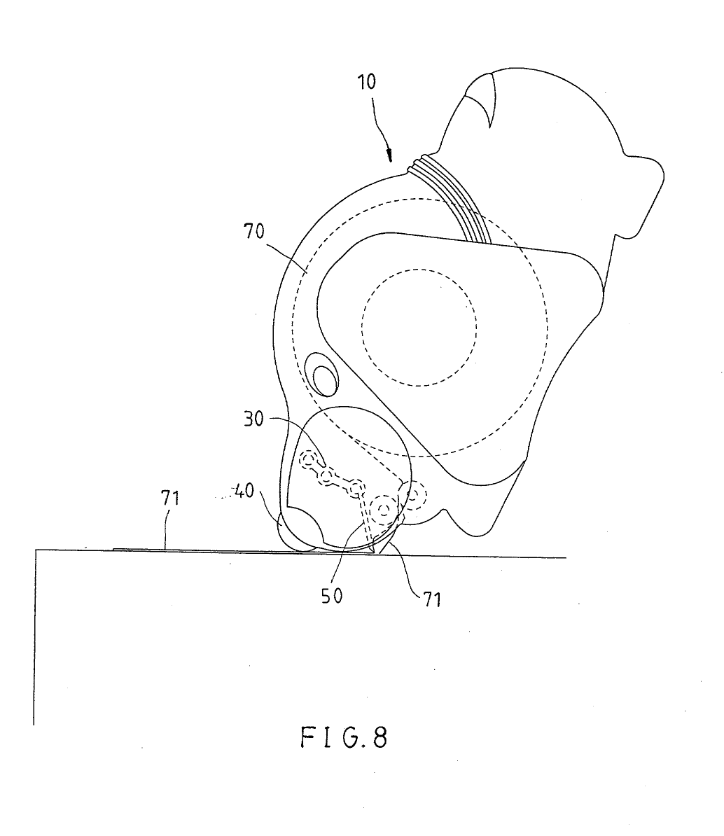

FIG. 8 shows the tape dispenser of the present invention in operating. First, user can stick the tail of the tape 71 on an object, and then, draw the tape dispenser along the object to make the tape 71 sticking on the object continually. If user turns the housing 10 an angle for the press member 40 pressing on the object, the cutter 50 will extend out of the housing 10 via the third aperture 15 to cut the tape 71 off as shown in FIG. 8. If user removes the tape dispenser from the object, the cutter 50 will run back into the housing 10 automatically.

What is claimed is:

1. A tape dispenser, comprising:
a housing, which is constructed from a first housing piece and a second housing to form a receiving chamber therein and an opening at a side thereof, having a first aperture and a second aperture communicated with said receiving chamber;
a tape seat having a base wall and two substantially parallel side walls, each of said side walls having a wheel seat at interior side thereof, a tape wheel detachably mounted in between said side walls on said wheel seats for free rotating, a second roller pivoted at front side of said base wall;
said tape seat detachably installed to said housing from said opening for said tape wheel and said second roller received in said housing and a third aperture formed in between the end of said base wall of said tape seat and said housing, wherein said third aperture next to said second aperture;
a coupler link received in said housing with the midsection thereof pivoted to said housing, said coupler link has a first segment and a second segment at the opposite sides of the pivot point thereon respectively;
a press member received in said housing for displacing within a predetermined distance, which has a part extending out of said housing via said first aperture of said housing and has an end pivoted to said first segment of said coupler link;
a cutter having an end thereof pivoted to said second segment of said coupler link and having a blade portion at the opposite end thereof, said blade portion of said cutter corresponding to said second aperture of said housing to be driven to displace for said blade portion extending out of said housing via said second aperture and running back into said housing, and
an elastic member having an end being against said housing and the other end being against said press member.

2. The tape dispenser as defined in claim 1, wherein said first housing piece of said housing has a guiding slot and said press member has a rod received in said guiding slot.

3. The tape dispenser as defined in claim 1, wherein said press member has two substantially parallel arms at the interior end thereof, each of which has a hole at distal end thereof, said coupler link has a hole at distal end of said first segment, a pin is inserted into said holes of said arms and said hole of said first segment.

4. The tape dispenser as defined in claim 1, wherein said housing has a seat block therein, which has a notch facing to said first aperture, said press member has a recess at interior end thereof, said elastic has an end received in said notch of said seat block and the other end received in said recess of said press member.

5. The tape dispenser as defined in claim 1, wherein said coupler link has a hole at distal end of said second segment, said cutter has two connect rods inserted into opposite ends of said hole of said second segment of said coupler link.

6. The tape dispenser as defined in claim 1, wherein said coupler link has a central hole at midsection thereof, each of said first housing piece and said second housing piece of said housing has a pivot seat inserted into the opposite ends of said central hole.

7. The tape dispenser as defined in claim 1, wherein said housing has a block wall therein between said first aperture and said second aperture.

8. The tape dispenser as defined in claim 1, wherein each of said first housing piece and said second housing piece of said housing has a tunnel extending to said opening of said housing, said side walls of said tape seat position at exterior side of said first housing piece and said second housing piece respectively.

9. The tape dispenser as defined in claim 1, wherein said housing pivots a first roller therein for free rotating.
